(19) United States
(12) Patent Application Publication
(10) Pub. No.: US 2005/0144302 A1
(43) Pub. Date: Jun. 30, 2005

(54) Apparatus and method for delivering video content to subscribers

(76) Inventors: Alfie Kirkpatrick, London (GB); Reehan Ellahi Sheikh, Middlesex (GB); Charles Dav Wilson, Surrey (GB)

Correspondence Address: ROTHWELL, FIGG, ERNST & MANBECK, P.C., 1425 K STREET, N.W., SUITE 800, WASHINGTON, DC, 20005, US

(21) Appl. No.: 10/486,382

(22) PCT Filed: Aug. 12, 2002
(86) PCT No.: PCT/GB02/03712

(30) Foreign Application Priority Data
Aug. 10, 2001 (GB) 0119591.6

(51) Int. Cl. G06F 15/16; G06F 7/00

(52) U.S. Cl. 709/231; 707/10

(57) ABSTRACT

An apparatus and method for delivering video content to subscribers comprises capturing a video record comprising video content, analysis the captured video record to produce markers identifying events in the content thereof, editing the captured video record to produce a series of video clips each pertaining to one or more events identified by the markers, and converting the video clips into data in a format suitable for transmission over a network. The thus produced data representing the converted video clips and data representing the markers is stored on a server, as is a record of subscriptions by subscribers. At a user interface a subscriber can select video content from the video record by identifying events therein. When a selection is made the selected video data is read from the server with reference to the marker data, is encrypted and is sent over a network to the user interface. The subscriber's record of subscription is checked and, depending on the subscription, decryption data is sent to the user interface to enable the transmitted encrypted video data to be decrypted for display of the selected video content at the user interface.

The invention relates to an apparatus and method for delivering video content to subscribers. The invention is particularly, but not exclusively, suitable for delivering sports content to sports fans via the Internet.

The coverage and broadcast of sporting events presents a problem for broadcasters because there are so many events being held that it is impractical to provide full coverage of all events. Also, while the technology is now available to provide so-called video-on-demand services, it is not possible to maintain a full library of all game, matches and events for selection by sports fans as and when they wish.

An alternative approach to providing sports content on demand is therefore needed. The Internet provides a suitable medium for such a service, but problems still remain including how best to make available the content, how best to allow the fans to select the content that they want to see, and how best to generate revenue from the service. The invention addresses these problems.

According to the present invention, there is provided a video distribution apparatus, the apparatus comprising:
a plurality video capture units for capturing video records;
an event coding unit for analysing the captured video records to produce markers identifying events in the video records;
an encoding unit for converting the captured video records into video clips each relating to one or more events identified by the markers and generating labels identifying the video clips;
a store for storing the video clips; and
a server for storing a database of the labels such that they can be browsed by a user and for transmitting stored video clip(s) to the user over a network in response to the user selecting the label(s) identifying the stored video clip(s) from the database.

According to another aspect of the present invention, there is provided a method of video distribution, the method comprising:
capturing video records;
analysing the captured video records to produce markers identifying events in the video records;
converting the captured video records into video clips each relating to one or more events identified by the markers;
generating labels identifying the video clips;
storing the video clips;
storing a database of the labels such that they can be browsed by a user; and
transmitting one or more stored video clip(s) to the user over a network in response to the user selecting the label(s) identifying the stored video clip(s) from the database.

Typically, the capture of video records comprises the recordal of video footage by one or more video cameras. It may also include the editing of such footage to eliminate unwanted footage. A video capture unit may therefore comprise one or more video cameras. It may also comprise a video editing apparatus.

The analysis of the video records might be carried out manually by an operator reviewing video tapes and inputting markers. The markers may include data relating to an event type and the start and end times of the event in the video footage. However, the analysis is preferably automated such that the start and end times of the event in the video footage are generated automatically from the elapsed time of the video footage. Furthermore, the event type data may be generated at least partly automatically using input codes that abbreviate the data, data input by other operators or a video recognition system for example.

The encoding may comprise the conversion of the video footage into data for transmission over a network. For example, the video clips may comprise data in accordance the Moving Picture Experts Group standards (MPEG) or be Microsoft®'s Media Player data files.

One possibility is that the video clips relate, or each relate, to the video record of an event identified by a marker. Another possibilty is that the video clips relate, or each relate, to the video record of plural events identified by plural markers or to an entire video record. Indeed, the video record of an event may be included in more than one clip or in none of the clips.

These options can be reflected in the labels as desired. The labels might therefore comprise information on the type of event in a clip, the date of a clip or the length or size of a clip. One example might be “Highlights of Manchester United v. Arsenal, 6 Apr. 2001, 2.08 MB” (Mega Bytes). Another example might be “Goal by David Beckham, Manchester United v. Arsenal, 6 Apr. 2001, 0.28 MB”.

The database of labels can be provided in a number of different ways. Typically, the database may comprise a web site, e.g. coded in HyperText Markup Language (HTML) as one or more web pages stored on a web server. The labels may then comprise links, e.g HTML links, to the video clip they identify. Such a database may be easily browsed, or be searchable by, a user.

According to another aspect of the invention there is provided an apparatus for delivering video content to subscribers, the apparatus comprising: means for capturing a video record comprising video content; means for analysing the captured video record to produce markers identifying events in the content thereof; means for editing the captured video record to produce a series of video clips each pertaining to one or more events identified by the markers; means for converting the video clips into data in a format suitable for transmission over a network; means for storing the data representing the converted video clips and data representing the markers; means for reading the stored video data with reference to the marker data and for transmitting the same over a network.

According to another aspect of the invention there is provided a method of delivering video content to subscribers, the method comprising: capturing a video record comprising video content; analysing the captured video record to produce markers identifying events in the content thereof; editing the captured video record to produce a series of video clips each pertaining to one or more events identified by the markers; converting the video clips into data in a format suitable for transmission over a network; storing the data representing the converted video clips and data representing the markers; reading the stored video data with reference to the marker data and transmitting the same over a network.

According to a further aspect of the invention there is provided an apparatus for supplying video content to a receiver for viewing thereat, the apparatus comprising: means for maintaining a record of a subscription by a subscriber at the receiver; means for storing data representing a plurality of video clips containing video content, and data representing markers pertaining to respective events in the video content of the video clips; means for encrypting video data representing selected clips for transmission over a network to the receiver; and means for sending to the receiver over the network decryption data for decrypting the encrypted video data, which decryption data is sent depending events selected by the subscriber and on the subscriber's record of subscription.

According to another aspect of the invention there is provided a method of supplying video content to a receiver for viewing thereat, the method comprising: maintaining a record of a subscription by a subscriber at the receiver; storing data representing a plurality of video clips containing video content, and data representing markers pertaining to respective events in the video content of the video clips; encrypting video data representing selected clips for transmission over a network to the receiver; and sending to the receiver over the network decryption data for decrypting the encrypted video data, which decryption data is sent depending events selected by the subscriber and on the subscriber's record of subscription.

The invention also provides an apparatus for providing video content from a video record to a subscriber via a network, the apparatus comprising: means for storing data representing a plurality of video clips containing video content, and data representing markers pertaining to respective events in the video content of the video clips; a user interface for enabling a user to select video content from the video record by identifying events therein; means for encrypting video data representing selected clips for transmission over a network to the user interface; and means for decrypting the transmitted encrypted video data for display of the selected video content at the user interface.

The invention further provides a method of providing video content from a video record to a subscriber via a network, the method comprising: storing data representing a plurality of video clips containing video content, and data representing markers pertaining to respective events in the video content of the video clips; selecting video content from the video record by identifying events therein; encrypting video data representing selected clips for transmission over a network to the user interface; and decrypting the transmitted encrypted video data for display of the selected video content.

The invention provides an apparatus comprising: means for capturing a video record comprising video content; means for analysing the captured video record to produce markers identifying events in the content thereof; means for editing the captured video record to produce a series of video clips each pertaining to one or more events identified by the markers; means for converting the video clips into data in a format suitable for transmission over a network; means for storing the data representing the converted video clips and data representing the markers; a user interface for enabling a user to select video content from the video record by identifying events therein; means for reading the selected video data with reference to the marker data; means for maintaining a record of a subscription by a subscriber at the receiver; means for encrypting the read video data representing selected clips for transmission over a network to the user interface; means for sending to the receiver over the network decryption data for decrypting the encrypted video data, which decryption data is sent depending events selected by the subscriber and on the subscriber's record of subscription; and means for decrypting the transmitted encrypted video data for display of the selected video content at the user interface.

The invention further provides a method comprising: capturing a video record comprising video content; analysing the captured video record to produce markers identifying events in the content thereof; editing the captured video record to produce a series of video clips each pertaining to one or more events identified by the markers; converting the video clips into data in a format suitable for transmission over a network; storing the data representing the converted video clips and data representing the markers; selecting video content from the video record by identifying events therein; reading the selected video data with reference to the marker data; maintaining a record of a subscription by a subscriber at the receiver; encrypting the read video data representing selected clips for transmission over a network; sending to the receiver over the network decryption data for decrypting the encrypted video data, which decryption data is sent depending events selected by the subscriber and on the subscriber's record of subscription; and decrypting the transmitted encrypted video data for display of the selected video content.

The above and further features of the invention are set forth with particularity in the appended claims and together with advantages thereof will become clearer from consideration of the following detailed description of an exemplary embodiment of the invention given with reference to the accompanying drawings, in which:

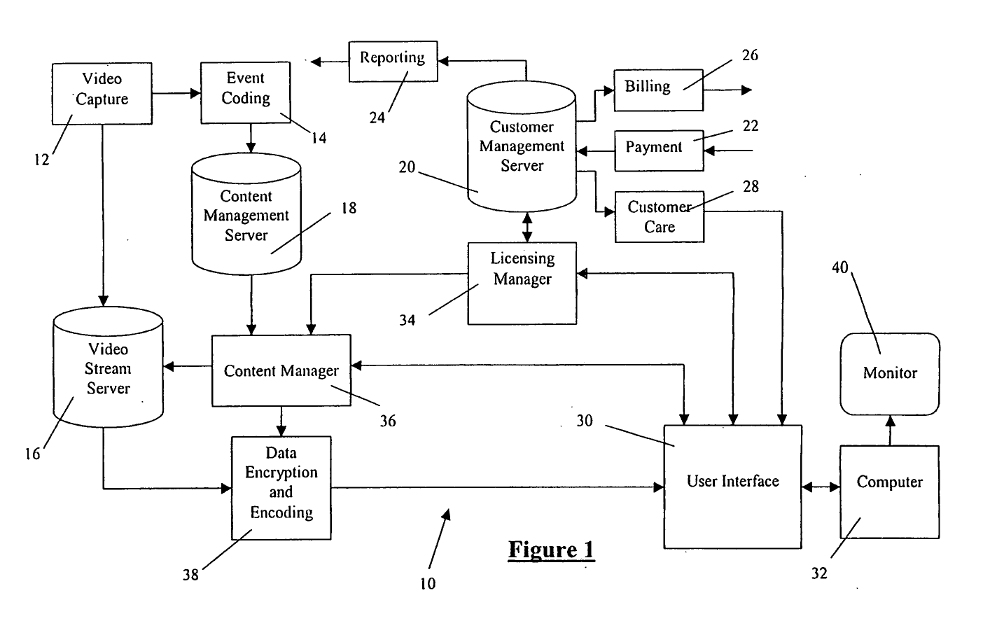

FIG. 1 is a schematic block diagram of a system embodying the invention;

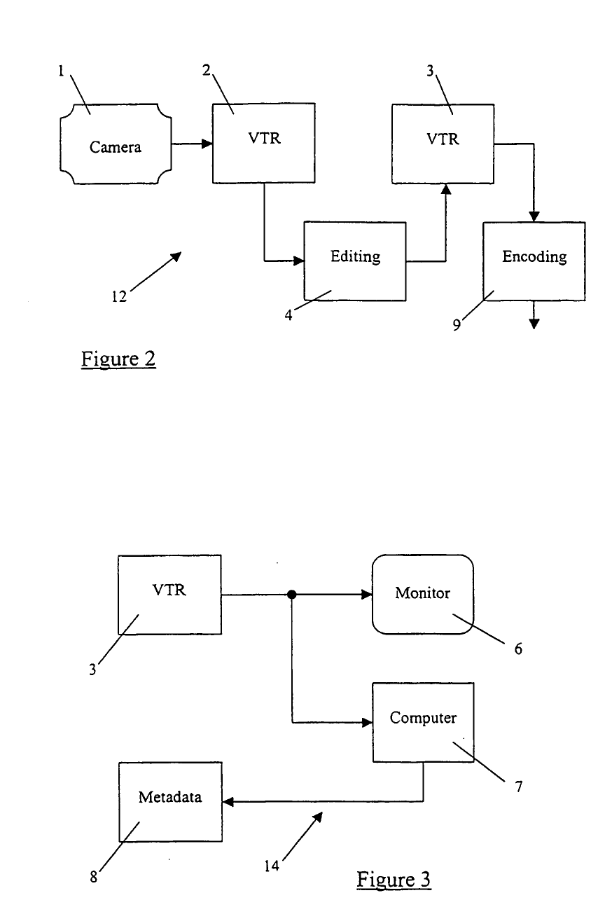

FIG. 2 is a schematic block diagram of a video capture unit used in the system of FIG. 1; and

FIG. 3 is a schematic block diagram of an event-coding unit used in the system of FIG. 1.

Turning now to FIG. 1 of the accompanying drawings, there is shown a schematic block diagram of a system 10 embodying the invention. The system 10 is configured to provide a video service to subscribers via the Internet. As used herein the term “video” is intended to encompass both visual and audible records. The system comprises a video capture unit 12, which typically consists of cameras and other recording equipment at a stadium for recording onto video tape or an equivalent medium action during a game, match or event. The system 10 is, of course, suitable for use with any sports event, or indeed any event where post-event interest would warrant recording and subsequent broadcast over the Internet. Nevertheless, for the sake of readability the following description is given by way of example with reference to a football (soccer) match or game.

The video capture unit 12 is shown in greater detail in FIG. 2 of the accompanying drawings as comprising a camera 1, a video editor comprising one or more video tape recorders (VTRs) 2, 3 together with an editing unit 4, and a formatting module 5. Video of a game from the camera 1 is recorded onto tape by one VTR 2, is edited for content by the editing unit 4 under the control of a human operator, and the edited content is recorded onto tape by the other VTR 3. The editing is usually performed to eliminate video that is of poor quality, e.g. out of focus or away from the action, and to select the best camera angles. As a commercial operation, it may also be desirable to carry advertisements relating to football in general, the game in particular or other, related services.

In practice several cameras sited at different locations around a ground or stadium will be used to capture a video record of the game, and the editing unit 4 will be used to select between the different cameras 1 to produce a video record optimised for full coverage of the game. The VTRs 2, 3 may be replaced by any one of the many alternative video recording media now available, including hard disk stores for example.

Once the video recording has been captured and edited, or indeed even during the capture of the video record, by the video capture unit 12, the video record is output to an event-coding unit 14 where events in the football match are recorded. The event-coding unit 14 is illustrated in FIG. 3 as comprising the VTR 3 (first shown in FIG. 2 hereof) on which the edited video record is stored, a monitor 6, on which the video is displayed, coupled to a computer 7 at which an operator inputs data, which data indexes the occurrence of predetermined events in the match. The operator-input data is therefore metadata, and may be referred to as such in the remainder of this specific description. The metadata may be stored in the computer 7, on a videotape or such like containing the record of the game or in a separate medium, represented by block 8 in FIG. 3, associated with the tape recording of the game.

Companies exist that create data about events in football matches and the like from video records of such matches. For example, the United Kingdom company Opta has for many years provided match statistics to newspapers and other media generated from video of football matches. Until now, this data has been supplied to newspapers, clubs, etc, in the form of statistics about the game. For example, the number of passes or shots on goal by each player might be provided. Similarly, the number of fouls committed by each player or the number of free kicks or corner kicks awarded to each team might be supplied. Therefore, operators practiced in the art of creating statistics from video are available.

The metadata created by the event-coding unit 14 is different than the data previously created by companies such as Opta in that it is metadata identifying the occurrence of events in the video record, and not just statistical data of the number of occurrences of given events during a match or game. In other words, the event coding unit 14 creates metadata that identifies particular video footage as relating to a particular event. The metadata might therefore comprise a marker associated with the video footage. For example, the metadata may comprise event type data, an event start time and an event finish time. The event type data might identify the event as one of a plurality of different predetermined events and the event start and finish times may identify the time on the video tape recording of the game that the event starts and finishes.

Alternatively, the metadata can identify the start of a particular sequence (for example a series of passes that result in a goal being scored), the end of the sequence, and the events occurring during the sequence (e.g. each pass, by which player, whether the player passed with his left or right foot and so on). The metadata may also indicate other events of interest surrounding the current event. For example, if the event were a red card send-off of a player, a related event of interest would be the foul (or whatever) that resulted in the player being shown the red card.

The metadata may be created to provide considerably more detail than just the identification of significant events in a game. Many different events may be identified, including, but not limited to, location of the event on the field, who kicked the ball, with which foot, where the ball came from, where it went to, consequences (if any) of the action, and so on.

Referring again to FIGS. 1 and 2, once the metadata has been created, the tape recording stored by the VTR 3 in the video capture unit 12, is reformatted or converted by an encoding unit 9 to a suitable format for delivery to subscribers over the Internet and output to a video stream server 16. The encoding unit 9 converts the video data from the format in which it is stored on tape (typically standard television broadcast resolution, e.g. 625/25 PAL or 525/30 NTSC) into a format suitable for streaming over the Internet. Proprietary applications, such as Microsoft's Windows Media and Real Networks' Real Producer, are widely available for this purpose. Indeed both applications may be used in order to provide users with a choice between different media viewers, including Windows Media Player and Real Player. Both versions of the data would be held in the video stream server 16. The video data should also be encoded at different resolutions to enable user access at different bandwidths, including 56k, ISDN and broadband rates.

During the reformatting process, mentioned hereinabove with respect to FIG. 2, the video is divided into clips showing action associated with events identified by the metadata. As will be explained in greater detail herein below, this enables a sequence of clips to be created in response to a request by a user for delivery over the Internet to the user.

In one example, the metadata generated in the event-coding unit 14 is stored in a content manager server 18. However, in addition to defining predetermined events in the game, the metadata, as stored in the content management server 18, may include pointers that identify the associated video clip of the event as stored in the video stream server. Thus, in another example, the metadata stored in the content manager server is labels for the clips. These labels may be generated from the metadata to provide a label database easily searchable by a user, as set out below. Although shown as separate units, the video stream server 16 and the content management server 18 may be provided in a single unit depending on how the system is implemented in practice.

Mirror sites may, of course, also be established at which either or both of the video stream server 16 and the content management server 18 are copied, in order to avoid bandwidth limitations associated with using only a single site during periods of high demand.

The system 10 further comprises a customer management system (CMS) which controls access to the video data. A customer management server 20 forms the core of the CMS. The customer management server 20 is connected to receive payment information 22 regarding the payment of subscription and other fees by a customer (also referred to herein as a user or a fan).

The customer management server 20 is shown as a separate unit because in practice it is likely to be located at an entirely different URL on the Internet. Of course, there is nothing to stop the customer management server 20 being provided in a single unit together with the video stream server 16 and/or the content management server 18, depending on how the system is implemented in practice. Preferably, however, the customer management server 20 is presented to the user via each football club's respective Web site. In this way the video service can be presented to the user as if it originates from the club's site.

Information regarding the payment for a service is input to the customer management server 20, as represented by the block 22 in FIG. 1. Payments may be made via several different routes including the sending of a cheque by mail, direct debit from a bank account, and credit card payments by telephone or via the Internet. It is envisaged that a user would make an initial payment by cheque or credit card and then be invited to subscribe, say, on a weekly, monthly or annual basis. When a payment is made (as represented by the block 22) the information in the customer management server 20 is updated. Changes in the level of service may also be made by the user, and that information too is updated as necessary in the customer management server 20.

The customer management server 20 may also be arranged: to generate reports for auditing purposes for example, as represented by block 24 in FIG. 1; to send out bills and receipts to users, as represented by block 26; and to interact with users by sending out adverts promoting a forthcoming event and receiving feedback from users on the services provided by the system, as represented by block 28.

User access to the system is enabled via a user interface 30. Typically, the user interface 30 is a web browser running on a computer 32 to which the user has access (i.e. typically the user's own personal computer). The user interface 30 provides a single point of contact for the user.

The user interface 30 presents to the user a series of Web pages that guide the user through a subscription process via secure link to the customer management server 20. Personal and financial information are requested and, as an alternative, contact numbers and addresses are provided to enable the user to subscribe via telephone or mail. Once the subscription process has been satisfactorily completed, the user is given a subscriber name or number and a password or PIN to allow secure access to the subscribed service.

Thereafter, when the user accesses the service to which he has subscribed, the user interface 30 connects via a secure encrypted Internet link to a licensing manager 34, which is, in turn, connected to the customer management server 20. The user is then asked to identify himself, by way of his subscriber name and PIN number. The information input to the user interface 30 by the user is passed to the licensing manager 34, which accesses the customer management server 20 to verify that the user is a subscribing customer.

The system 10 further comprises a content manager 36 connected to the licensing manger 34. Once the licensing manager 34 has verified that the user is authorised to access the video streams, it sends data to the content manager 36 confirming the validity of the user and identifying the level of service for which the user has subscribed.

The system 10 is configured to provide a variety of different levels of service to users. A basic service package may for example enable the user to access only edited highlights of a game, which highlights are predetermined by the service provider and stored as a clip in the video stream server 16 or possibly specified in advance by the user. A more comprehensive service package may for example allow the user to select highlights of his choosing in addition to the predetermined highlights of the basic package. A full service package may additionally allow the user to access video of the entire game and even archived video of past games. The services that will be made available are specified by the service provider and are dependent on the payment of appropriate fees by the user.

In the case of the more comprehensive packages, the user interface 30 allows the user to select predefined types of events including penalties, corners, goals, etc.. from the label database. The user can also search for events which have been identified by the metadata created in the event-coding unit 14 by searching to label database. Thus, for example, the user might choose to view all headers in the game, all contact with the ball by a given player or all tackles which result in control of the ball being taken successfully from the other team. The user interface 30 includes applets which enable the user to search the label database.

The content manager 36 is connected to the video stream server 16 and the content management server 18. In response to requests made by the user via the user interface 30, the content manager 36, using data from the content manager server 18, accesses video clips in the video stream server 16. The accessed data is output from the video stream server 16 to a data encryption and encoding unit 38. Here the video data is encrypted and encoded before being streamed via the Internet to the user interface 30.

While video streaming works well on higher bandwidth connections, it is less satisfactory on links of 56k or less. When the user establishes a connection with the system, part of the information that he sends out includes information regarding the bandwidth of his connection. Where the user has a slow connection, the content manager 34 compiles the selected clips into a single file (e.g. an *.avi file) which is downloaded entirely to the user's computer before playback begins. In this way, a slow link will not result in the user receiving a poorer quality image.

Since video is streamed or downloaded in encrypted form from the video stream server 16 to the user interface 30, it is necessary for the user interface to have the correct decryption keys or codes to enable the video data to be decoded and the video content viewed by the user. The video includes a header that identifies a location at the licensing manager 34 where the encryption key is stored. The user interface 30 therefore accesses the licensing manager 34 to obtain the appropriate encryption key therefrom. In this way the user interface 30 is enabled to receive and decrypt the video data from the video stream server 16.

The thus received video data is then decoded using the decryption key sent to the user interface 30 by the licensing manager 34 for display of the video content represented by the video data on the monitor 40 of the user's computer 32.

Having thus described the invention by reference to a preferred embodiment it is to be well understood that the embodiment in question is exemplary only and that modifications and variations such as will occur to those possessed of appropriate knowledge and skills may be made without departure from the scope of the invention as set forth in the appended claims and equivalents thereof.

1. A video distribution apparatus, the apparatus comprising
a plurality of video capture units for capturing video records;
an event coding unit for analysing the captured video records to produce markers identifying events in the video records;
an encoding unit for converting the captured video records into video clips each relating to one or more events identified by the markers and generating labels identifying the video clips;
a store for storing the video clips; and
a server for storing a database of the labels such that they can be browsed by a user and for transmitting stored video clip(s) to the user over a network in response to the user selecting the label(s) identifying the stored video clip(s) from the database.

2. The apparatus of claim 1, further comprising a user management unit for restricting the video clips that can be transmitted to a particular user according to the type of licence held by the particular user.

3. The apparatus of claim 1, further comprising an encryption unit for encrypting video clips for transmission to the user over the network.

4. The apparatus of claim 3, further comprising a licensing unit for providing a decryption key to the user to decrypt the selected and transmitted video clip(s).

5. A method of video distribution, the method comprising:
capturing video records;
analysing the captured video records to produce markers identifying events in the video records;
converting the captured video records into video clips each relating to one or more events identified by the markers;
generating labels identifying the video clips;
storing the video clips;
storing a database of the labels such that they can be browsed by a user; and
transmitting one or more stored video clip(s) to the user over a network in response to the user selecting the label(s) identifying the stored video clip(s) from the database.

6. The method of claim 5, further comprising restricting the video clips that can be transmitted to a particular user according to the type of licence held by the particular user.

7. The apparatus of claim 5, further comprising encrypting video clips for transmission to the user over the network.

8. The apparatus of claim 7, further comprising providing a decryption key to the user to decrypt the selected and transmitted video clip(s).

9. An apparatus for delivering video content to subscribers, the apparatus comprising:
means for capturing a video record comprising video content;
means for analysing the captured video record to produce markers identifying events in the content thereof;
means for editing the captured video record to produce a series of video clips each pertaining to one or more events identified by the markers;
means for converting the video clips into data in a format suitable for transmission over a network;
means for storing the data representing the converted video clips and data representing the markers; and
means for reading the stored video data with reference to the marker data and for transmitting the same over a network.

10. A method of delivering video content to subscribers, the method comprising:
capturing a video record comprising video content;
analysing the captured video record to produce markers identifying events in the content thereof;
editing the captured video record to produce a series of video clips each pertaining to one or more events identified by the markers;
converting the video clips into data in a format suitable for transmission over a network;
storing the data representing the converted video clips and data representing the markers; and
reading the stored video data with reference to the marker data and transmitting the same over a network.

11. An apparatus for supplying video content to a receiver for viewing thereat, the apparatus comprising:
means for maintaining a record of a subscription by a subscriber at the receiver;
means for storing data representing a plurality of video clips containing video content, and data representing markers pertaining to respective events in the video content of the video clips;
means for encrypting video data representing selected clips for transmission over a network to the receiver; and
means for sending to the receiver over the network decryption data for decrypting the encrypted video data, which decryption data is sent depending events selected by the subscriber and on the subscriber's record of subscription.

12. A method of supplying video content to a receiver for viewing thereat, the method comprising:
maintaining a record of a subscription by a subscriber at the receiver;
storing data representing a plurality of video clips containing video content, and data representing markers pertaining to respective events in the video content of the video clips;
encrypting video data representing selected clips for transmission over a network to the receiver; and
sending to the receiver over the network decryption data for decrypting the encrypted video data, which decryption data is sent depending events selected by the subscriber and on the subscriber's record of subscription.

13. An apparatus for providing video content from a video record to a subscriber via a network, the apparatus comprising:
means for storing data representing a plurality of video clips containing video content, and data representing markers pertaining to respective events in the video content of the video clips;
a user interface for enabling a user to select video content from the video record by identifying events therein;
means for encrypting video data representing selected clips for transmission over a network to the user interface; and
means for decrypting the transmitted encrypted video data for display of the selected video content at the user interface.

14. A method of providing video content from a video record to a subscriber via a network, the method comprising:
storing data representing a plurality of video clips containing video content, and data representing markers pertaining to respective events in the video content of the video clips;
selecting video content from the video record by identifying events therein;
encrypting video data representing selected clips for transmission over a network to the user interface; and
decrypting the transmitted encrypted video data for display of the selected video content.

15. An apparatus comprising
means for capturing a video record comprising video content;
means for analysing the captured video record to produce markers identifying events in the content thereof;
means for editing the captured video record to produce a series of video clips each pertaining to one or more events identified by the markers;
means for converting the video clips into data in a format suitable for transmission over a network;
means for storing the data representing the converted video clips and data representing the markers;
a user interface for enabling a user to select video content from the video record by identifying events therein;
means for reading the selected video data with reference to the marker data;
means for maintaining a record of a subscription by a subscriber at the receiver;
means for encrypting the read video data representing selected clips for transmission over a network to the user interface;
means for sending to the receiver over the network decryption data for decrypting the encrypted video data, which decryption data is sent depending events selected by the subscriber and on the subscriber's record of subscription; and
means for decrypting the transmitted encrypted video data for display of the selected video content at the user interface.

16. A method comprising:
capturing a video record comprising video content;
analysing the captured video record to produce markers identifying events in the content thereof;
editing the captured video record to produce a series of video clips each pertaining to one or more events identified by the markers;
converting the video clips into data in a format suitable for transmission over a network;
storing the data representing the converted video clips and data representing the markers;
selecting video content from the video record by identifying events therein;
reading the selected video data with reference to the marker data;
maintaining a record of a subscription by a subscriber at the receiver;
encrypting the read video data representing selected clips for transmission over a network;
sending to the receiver over the network decryption data for decrypting the encrypted video data, which decryption data is sent depending events selected by the subscriber and on the subscriber's record of subscription; and
decrypting the transmitted encrypted video data for display of the selected video content.

17. The apparatus of claim 2, further comprising an encryption unit for encrypting video clips for transmission to the user over the network.

18. The apparatus of claim 17, further comprising a licensing unit for providing a decryption key to the user to decrypt the selected and transmitted video clip(s).

19. The apparatus of claim 6, further comprising encrypting video clips for transmission to the user over the network.

20. The apparatus of claim 19, further comprising providing a decryption key to the user to decrypt the selected and transmitted video clip(s).
